(19) United States
(12) Patent Application Publication
(10) Pub. No.: US 2010/0024797 A1
(43) Pub. Date: Feb. 4, 2010

(54) Auxiliary opening/closing mechanism for a cover of a roasting stove

(76) Inventor: Kao Hsung Tsung, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/219,873

(22) Filed: Jul. 30, 2008

(51) Int. Cl. A47J 37/07; B66D 1/04

(52) U.S. Cl. 126/25 R; 254/264

(57) ABSTRACT

An auxiliary opening/closing mechanism for a cover of a roasting stove, the mechanism can improve the roasting stove to eliminate the defect resided in using a thick and heavy metallic roasting stove cover which makes uneasy for opening and closing the auxiliary mechanism is connected with a rope on the rear of it, the rope extends down along the back of the roasting stove, and one end of the rope has a pending counterbalance weight, the weight of the counterbalance weight pulls the roasting stove cover to help to open it, thereby the roasting stove cover gets rid of the trouble of being uneasy for opening and closing being due to its thickness and heaviness.

### BACKGROUND OF THE INVENTION

1. Field of the invention

The present invention relates to a mechanism used on a roasting stove, and especially to an auxiliary opening/closing mechanism for a cover of the roasting stove.

2. Description of the Prior Art

For obtaining better effect of roasting, saving energy source and avoiding dissipation of odor of roasting, a generally used roasting stove normally is provided on its top with a metallic roasting stove cover, the metallic roasting stove cover is made quite thick and heavy in order to keep the effect of roasting.

However, a thick and heavy roasting stove cover makes a user quite inconvenient in taking out/putting in food in opening/closing the roasting stove cover; on the contrary, a thin and light roasting stove cover may affect the quality of food roasted.

The above problem of being overly heavy of a roasting stove has been being a trouble for manufacturers and users, some manufacturers of roasting stove added springs or oil pressure equipment in roasting stove covers to expect easily opening/closing the covers, but by virtue that the interior temperatures of the roasting stove covers are very high during roasting, the life of use of the elements or equipment of the covers will be seriously affected, and thereby the method for solving the above problem including adding springs or oil pressure equipment in roasting stove covers is not perfect.

In view of the above stated, the inventor of the present invention provides a brand new auxiliary opening/closing mechanism for a cover of a roasting stove based on his experience of years, the opening/closing mechanism can help opening/ closing the roasting stove cover, so that opening/closing the roasting stove cover becomes easy and is not hard for operation by being overly heavy.

### SUMMARY OF THE INVENTION

The main object of the present invention is to provide an auxiliary opening/closing mechanism for a cover of a roasting stove; the mechanism can improve the roasting stove to obtain a better roasting effect, and can eliminate the defect that using a thick and heavy metallic roasting stove cover makes a user uneasy for opening and closing.

In order to achieve the above object, the auxiliary opening/closing mechanism for a cover of a roasting stove of the present invention is connected with a rope on the rear of it, the rope extends down along the back of the roasting stove, and one end of the rope has a pending counterbalance weight; the roasting stove further is provided thereon with at least a pulley for positioning of the rope and making the rope smooth and fluent in moving; and in operation, by the weight of the counterbalance weight, the weight of the roasting stove cover can be balanced, thereby the roasting stove cover gets rid of the trouble of being uneasy for opening and closing being due to its thickness and heaviness.

In practicing, the above stated roasting stove cover can be provided on the rear of it with a hanging ring for the convenience of mounting and processing of the rope; the hanging ring can be connected with the roasting stove cover by welding, screw connecting or being extended therethrough to make uneasy of dropping, and the shape of the hanging ring can be any of various annular shapes such as a circular shape.

One end of the rope is fixed on the rear side of the roasting stove cover, the rope extends down along the back of the roasting stove, and one end of the rope has a counterbalance weight hung thereon and connected therewith; when in practicing, the rope is a steel rope that increases the strength of the rope to assure it not to drop when it is connected with the counterbalance weight, and the diameter of the rope can be reduced to be beneficial to the appearance of the whole stove.

By virtue that the rope is provided on the rear side of the roasting stove cover and extends down along the back of the roasting stove, and one end of it has a counterbalance weight hung thereon and connected therewith, the weight of the counterbalance weight pulls the roasting stove cover to balance with the weight of the roasting stove cover itself, so that when in opening/closing the roasting stove cover, operation for opening/closing the roasting stove cover will not become uneasy being due to the designing of larger thickness and heaviness; and when in practicing, a counterbalance weight can be chosen from various counterbalance weights of different weights according to the roasting stove cover used.

In mounting the above stated pulley, the pulley can be mounted at a turning on the back side of the roasting stove cover, providing of the pulley can allow positioning of the rope to avoid the rope from direct contact with and abrade the roasting stove to induce impedance force that will make the rope uneasy for moving or to damage the surface of the roasting stove. And when in practicing, the base of the pulley can be connected to the back side of the roasting stove by welding, screw connecting, sticking or engaging. Besides, the amount of the pulley can be decided in pursuance of the amount of turnings on the back side of the roasting stove. If the back side of the roasting stove is in the shape of smooth arc, 2 or 3 pulleys can be used for mounting to assure better stability and smoothness; and more, in addition to pulleys, fixed slide rails can be provided to increase stability and smoothness of the moving rope, the slide rails can be provided along the back of the roasting stove.

With the above structure, by virtue that the rope is fixed on the rear of the roasting stove cover, and extends down along the back of the roasting stove with the counterbalance weight hung on one end of it; when in use, the rope can have its stability and smoothness increased by positioning of the pulleys, and the weight of the counterbalance weight can pull the roasting stove cover to balance the weight of the roasting stove cover, in this mode, a user can feel easy, smooth and light in opening/closing the roasting stove cover.

In comparison with the conventional technique, by providing the counterbalance weight and the pulleys, operation in opening/closing the roasting stove cover can be easy and smooth without feeling of heaviness; and the cost of manufacturing of the present invention is low, the process of operation of the present invention is simple, by virtue that the counterbalance weight and the pulleys are mounted at the rear side of the roasting stove cover, the life of use of the elements of the cover will not be affected the high temperature during roasting, and by the fact that the present invention is provided on the rear side of the roasting stove cover, it will not affect the appearance of the whole stove.

The present invention will be apparent after reading the detailed description of the preferred embodiment thereof in reference to the accompanying drawings.

### BRIEF DESCRIPTION OF THE DRAWINGS

FIG. 1 is a side view of the present invention;

FIG. 2 is a rear side view of the present invention.

### DETAILED DESCRIPTION OF THE PREFERRED EMBODIMENT

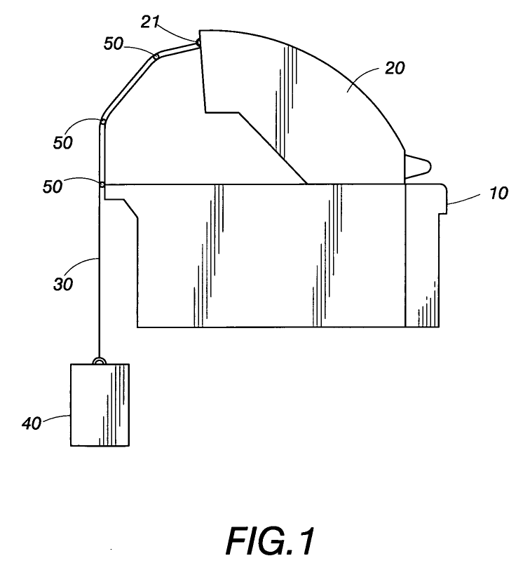

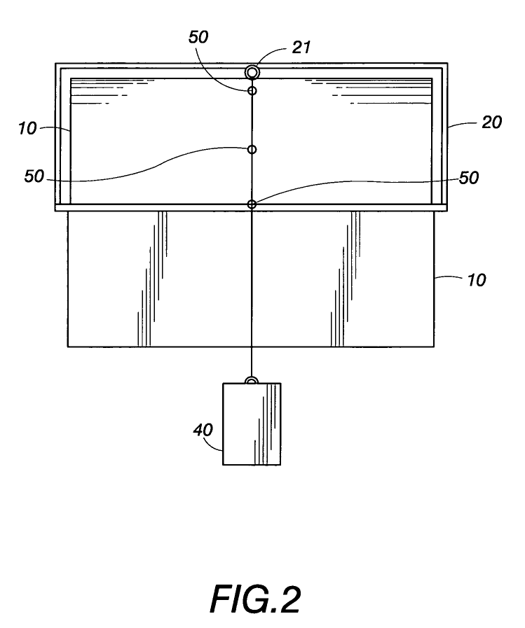

As shown in FIGS. 1 and 2, an auxiliary opening/closing mechanism for a cover 20 of a roasting stove 10 of the present invention is connected with a rope 30 on the rear of the roasting stove cover 20 of the roasting stove 10, and one end of the rope 30 has a pending counterbalance weight 40; the roasting stove 10 further is provided thereon with at least a pulley 50 for positioning of the rope 30.

When in practicing, the above stated roasting stove cover 20 can be provided at the rear of it with a hanging ring 21 for the convenience of mounting and processing of the rope 30; the hanging ring 21 can be connected with the roasting stove cover 20 by welding, screw connecting or being extended therethrough to make uneasy of dropping, and the shape of the hanging ring 21 can be any of various annular shapes such as a circular shape.

One end of the rope 30 is fixed on the rear side of the roasting stove cover 20, the rope 30 extends down along the back of the roasting stove 10, and one end of the rope 30 has the counterbalance weight 40 hung thereon; when in practicing, the rope 30 is a steel rope that increase the strength of the rope to assure it not to drop when it is connected with the counterbalance weight 40, and the diameter of the rope 30 can be reduced to be beneficial to the appearance of the whole stove.

By virtue that the rope 30is provided on the rear side of the roasting stove cover 20 and extends down along the back of the roasting stove 10, and one end of it has the counterbalance weight 40 hung thereon, the weight of the counterbalance weight 40 pulls the roasting stove cover 20 to balance with the weight of the roasting stove cover 20 itself, so that when in opening/closing the roasting stove cover 20, operation for opening/closing the roasting stove cover 20 will not become uneasy being due to the designing of larger thickness and heaviness; and when in practicing, the counterbalance weight 40 can be chosen from various counterbalance weights of different weights according to the roasting stove cover 20 used.

In mounting the above stated pulley 50, the pulley 50 can be mounted at a turning on the back side of the roasting stove 10, providing of the pulley 50 can allow positioning of the rope 30 to avoid the rope 30 from direct contact with and abrade the roasting stove 10 to induce impedance force that will make the rope 30 uneasy for moving or to damage the surface of the roasting stove 10. And when in practicing, the base of the pulley 50 can be connected to the back side of the roasting stove 10 by welding, screw connecting, sticking or engaging. Besides, the amount of pulley can be decided in pursuance of the amount of turnings on the back side of the roasting stove 10. If the back side of the roasting stove 10 is in the shape of smooth arc, 2 or 3 pulleys can be used for mounting to assure better stability and smoothness; and more, in addition to pulleys, fixed slide rails can be provided to increase stability and smoothness of the moving rope 30, the slide rails can be provided along the back of the roasting stove 10.

With the above structure, by virtue that the rope 30 is fixed on the rear of the roasting stove cover 20, and extends down along the back of the roasting stove 10 with the counterbalance weight 40 hung on one end of it; and at least a pulley 50 is provided for positioning of the rope 30 to increase stability and smoothness of the moving rope 30; thereby when in use, the weight of the counterbalance weight 40 can pull the roasting stove cover 20 to balance the weight of the roasting stove cover 20, in this mode, a user can feel easy and light in opening/closing the roasting stove cover 20.

Although this invention has been disclosed and illustrated with reference to particular embodiment, this is only for illustrating the preferred embodiment of the present invention, and not for giving any limitation to the scope of the present invention. It will be apparent to those skilled in this art that various equivalent modifications or changes without departing from the spirit, scope and characteristic of this invention shall fall within the scope of the appended claims.

1. An auxiliary opening/closing mechanism for a cover of a roasting stove, wherein a rope is connected on a rear side of said roasting stove cover, said rope extends down along a back side of said roasting stove with a counterbalance weight hung on one end of it; weight of said counterbalance weight pulls said roasting stove cover to help to open said roasting stove cover.

2. The auxiliary opening/closing mechanism for a cover of a roasting stove as in claim 1, wherein at least a pulley is provided on said back side of said roasting stove for positioning and to increase moving smoothness of said rope.

3. The auxiliary opening/closing mechanism for a cover of a roasting stove as in claim 1, wherein said rope is fixed on said rear side of said roasting stove cover for positioning and to increase moving smoothness of said rope.

4. The auxiliary opening/closing mechanism for a cover of a roasting stove as in claim 1, wherein said rope is a steel rope.

5. The auxiliary opening/closing mechanism for a cover of a roasting stove as in claim 1, wherein a hanging ring is provided on said rear side of said roasting stove cover, said roasting stove cover is connected with said rope through said hanging ring.
